(19) United States
(12) Patent Application Publication
(10) Pub. No.: US 2026/0142096 A1
(43) Pub. Date: May 21, 2026

(54) SWITCHING UNIT

(71) Applicant: Ellenberger & Poensgen GmbH, Altdorf (DE)

(72) Inventors: Steffen DIETZ, Schwanstetten (DE); Albert GERNGROSS, Hilpoltstein (DE); Stefan HOLBE, Nuernberg (DE); Julian KAISER, Erlangen (DE); Hendrik-Christian KOEPF, Nuernberg (DE)

(73) Assignee: Ellenberger & Poensgen GmbH, Altdorf (DE)

(21) Appl. No.: 19/446,358

(22) Filed: Jan. 12, 2026

Related U.S. Application Data
(63) Continuation of application No. PCT/EP2023/071610, filed on Aug. 3, 2023.

(30) Foreign Application Priority Data
Jul. 12, 2023 (DE) 10 2023 206 639.4

(51) Int. Cl. H01H 9/34; H01H 9/36; H01H 9/44; H02B 1/18; H02B 1/20

(52) U.S. Cl. CPC H01H 9/346; H01H 9/443; H01H 9/446; H02B 1/18; H02B 1/20; H01H 2009/365

(57) ABSTRACT

A switching unit having a fixed contact, a movable contact that is mounted so as to be movable relative to the fixed contact, and a quenching element which are all arranged in a quenching chamber. The fixed contact is connected to a first limb of a busbar which is U-shaped at least in sections and therefore has a second limb. The switching unit comprises a U-shaped magnetic circuit for driving an arc formed between the fixed contact and the movable contact into the quenching element, the magnetic circuit comprising a driving element which is positioned between the first limb and the second limb and which is perpendicular to two parallel side surfaces of the magnetic circuit. The quenching chamber is positioned between the two side surfaces. The invention also relates to a module of a switching unit and to a circuit breaker.

This nonprovisional application is a continuation of International Application No. PCT/EP2023/071610, which was filed on Aug. 3, 2023, and which claims priority to German Patent Application No. 10 2023 206 639.4, which was filed in Germany on Jul. 12, 2023, and which are both herein incorporated by reference.

### BACKGROUND OF THE INVENTION

### Field of the Invention

The invention relates to a switching unit comprising a fixed contact and a movable moving contact that is mounted so as to be movable relative to the fixed contact. The invention also relates to a circuit breaker.

### Description of the Background Art

Increasingly, motor vehicles, such as commercial vehicles, i.e., buses or trucks, feature one or more electric motors as their main drive system, which directly serves propulsion. A high-voltage battery is usually provided to operate the electric motor(s), which provides a DC voltage at a level of between 400 V and 800 V. The electrical currents between the high-voltage battery and the electric motor amount to several 10 A during operation.

In the event of a fault, such as a short circuit or an accident, it is necessary to electrically disconnect the high-voltage battery from other components of the vehicle, such as the electric motor. For this purpose, a circuit breaker is generally used, which has a switching unit that is inserted into a current path existing between the high-voltage battery and the electric motor. The circuit breaker is designed in such a way that if a certain limit value is exceeded by the electric current guided by the current path, the switch is actuated so that the electrical current flow is interrupted.

For example, a semiconductor switch is provided as a switch. However, comparatively high electrical losses occur during operation, which reduces efficiency and thus also the range of the vehicle. Alternatively, a (mechanical) relay is provided as a switch, which has a fixed contact and a movable moving contact that is mounted so as to be movable relative to the fixed contact. To interrupt the flow of current, the moving contact is separated from the fixed contact so that mechanical separation occurs. As a result, the DC voltage begins to apply between the fixed contact and the moving contact, which leads to ionization of the air between the two contacts. An electric current flow in the form of an arc is possible via the ionized air, although the two contacts are mechanically separated from each other. Thus, the other components of the motor vehicle will continue to be supplied by the high-voltage battery, which is why the desired safety is not achieved immediately. The arc also causes a thermal load on the area around the switch.

It is therefore necessary to extinguish the arc as quickly as possible if it has occurred. For this purpose, a quenching plate stack is usually used, which is arranged adjacent to the switch. The quenching plate stack includes several individual quenching plates as well as a blowing device, for example in the form of an electric coil. Via this, a magnetic field is created that acts on the arc, which acts as an electrical conductor. The electric coil is usually oriented in such a way that the acting Lorentz force drives the arc into the quenching plate stack. There, its length is increased, and it is possible for it to be divided into several individual (partial) arcs, each of which is formed between adjacent quenching plates. As a result, the electrical voltage required to maintain the arc increases. If this is greater than the electrical voltage between the moving contact and the fixed contact, the arc collapses and the electric current flow is stopped. In order to safely drive the arc into the quenching plate stack, a precise and captive arrangement of the electrical coil is required, which makes production more difficult.

### SUMMARY OF THE INVENTION

It is therefore an object of the present invention to specify a particularly suitable switching unit, a particularly suitable module of a switching unit and a particularly suitable circuit breaker, wherein safety is advantageously increased and/or production is simplified.

The switching unit can have a fixed contact and a movable moving contact that is mounted so as to be movable relative to the fixed contact. In particular, the fixed contact and the moving contact are part of a mechanical switch. At least the switching unit, especially the switch, preferably has a mechanism via which the moving contact is movably mounted with respect to the fixed contact. In particular, it is possible to place the moving contact in such a way that it is mechanically directly in contact with the fixed contact. In particular, it is also possible to space the moving contact from the fixed contact so that an air gap is formed between them. Preferably, the distance between the fixed contact and the moving contact is greater than or equal to 0.5 cm, 1 cm or 2 cm. For example, during a movement, the moving contact is moved transversely with respect to the fixed contact. However, a rotary movement is also particularly preferred, so that the moving contact is swiveled to the fixed contact. In this way, the construction is simplified. When the switching unit is actuated, the position of the moving contact in relation to the fixed contact is changed. When the switching unit is opened, the moving contact is preferably spaced from the fixed contact.

The switching unit also can include a quenching element. The quenching element, for example, is made of porous ceramics. However, it is particularly preferred for the quenching element to have several quenching strips that are stacked on top of each other in one stacking direction. In particular, the quenching element thus comprises several quenching strips, in particular at least two quenching strips and, suitably, less than 100 quenching strips. Preferably, the number of strips is between 5 and 80, between 8 and 50, or between 10 and 30. Suitably, the number of quenching strips is less than or equal to 20. The quenching strips are designed flat and thus each only extend over one plane. Perpendicular to this plane, the extent of each quenching strip is reduced, and the extension, also known as thickness, is conveniently less than or equal to 5 mm, 4 mm, 3 mm, 2 mm, 1.5 mm or 1 mm. The quenching strips are conveniently arranged perpendicular to the direction of stacking and parallel to each other. Preferably, the projections of the quenching strips overlap each other at least partially, preferably completely, parallel to the direction of the stack. This provides a comparatively compact quenching chamber. The quenching strips, for example, are made of a ceramic that is electrically non-conductive and preferably thermally conductive. Oxide ceramics, such as silicate ceramics or aluminum oxide ceramics (AlO3), are particularly preferred as ceramics. In an alternative, a cordierite is used as the material.

Alternatively, the quenching strips can be made of a metal, for example of an iron, preferably an iron sheet. Appropriately, the quenching strips are designed to be ferromagnetic. In another alternative, the quenching strips are made of different materials, for example partly from a ceramic and partly from a metal. In particular, these are arranged alternately in the stacking direction.

For example, the quenching strips can be arranged congruently with respect to each other in the direction of the stack and spaced apart from each other. Alternatively, these are at least grouped together, with only partial overlap between the groups. In particular, a meandering gap is formed between the individual groups. For example, the quenching element includes a holder or the like, via which the individual quenching strips are stabilized in relation to each other.

The switching unit can also include a quenching chamber. The fixed contact, the moving contact and the quenching element are arranged in the quenching chamber. In particular, the quenching chamber stabilizes the quenching element and at least the fixed contact with each other, which simplifies construction. Expediently, the quenching chamber is enclosed, in particular at least the area between the quenching element and the moving contact as well as the fixed contact is enclosed. Thus, if an arc occurs between the moving contact and the fixed contact when the switching unit is actuated, it is surrounded by the quenching chamber so that uncontrolled spread of the arc is prevented. The quenching chamber also avoids thermal stress on other components. In particular, the quenching chamber is made of a plastic, preferably a polybutylene terephthalate (PBT) or a polyamide 66.

The switching unit can also have a busbar, which can be in a U-shape, at least in sections. In particular, the busbar is designed in a U-shape at the end. Thus, the busbar has a first limb and a second limb, which are essentially parallel to each other. In other words, the busbar is bent on itself so that the two limbs are formed. For example, an amount of an angle between the two limbs is less than 20°, 15°, 10°, 5°, or essentially equal to 0°. For example, the two limbs are the same length, or the first limb is shortened. The fixed contact is connected to the first limb, especially to its end. Appropriately, the fixed contact is connected to the side of the first limb opposite the second limb. In particular, the busbar ends at the fixed contact. For example, the fixed contact is made of the same material as the busbars and these are conveniently molded to each other and, in particular, single-piece with each other. Alternatively, for example, the fixed contact can be made of a different material, which, for example, increases fire safety. Conveniently, the busbar is made of copper or aluminum. In particular, a terminal or the like for connecting the switching unit to other components of the circuit is attached at the end of the second limb, such as a terminal or a plug.

The switching unit can also comprise a U-shaped magnetic circuit for driving the arc formed between the fixed contact and the moving contact into the quenching element. In other words, the magnetic circuit is suitable, in particular provided and set up, to drive the arc into the quenching element, provided that the arc is present between the fixed contact and the moving contact. In other words, the magnetic circuit drives the arc into the quenching element when it is formed due to a separation of the moving contact from the fixed contact, i.e., in particular when switching/actuating the switching unit. In particular, the magnetic circuit is designed in such a way that the arc is deformed/moved due to the Lorentz force acting on the arc, so that part of it enters the quenching element. In particular, when the arc enters the quenching element, a length of the quenching element is increased or, depending on the design of the quenching element, it is divided into several arcs, so that an electrical voltage required to maintain the arc(s) increases. Alternatively or in combination with this, the quenching element is used to cool the arc, in particular the plasma, if any, which is why the electrical voltage required to maintain the arc also increases.

The magnetic circuit can be designed in a U-shape, so that the magnetic field lines guided by the magnetic circuit are U-shaped. Between the ends of the magnetic circuit, the magnetic field lines emerge from the magnetic circuit, from the two parallel limbs of the U-shape, wherein an essentially constant magnetic field is formed, and wherein the magnetic field lines are essentially perpendicular to the two limbs of the magnetic circuit.

The magnetic circuit can comprise a driving element via which the magnetic field is provided in particular. Here, the driving element can be, for example, a permanent magnet, which is made of a ferromagnetic material, for example. In particular, the driving element is made of ferrite. In an alternative to this, the driving element can be, for example, a neodymium magnet. If the switching unit is used, for example, to switch an alternating voltage, the driving element is designed in such a way that a magnetic field is provided due to induction in it. In particular, in this case, the driving element is made of steel. In particular, magnetic coupling with other components of the switching unit takes place. The driving element is arranged between the first limb and the second limb. Preferably, the driving element is located in the area of a bend in the busbar, via which the U-shape is provided.

Furthermore, the magnetic circuit can have two side surfaces that are magnetically coupled to the driving element. For example, these can lie against each other or, for practical reasons, have a comparatively small distance between them, for example less than 0.5 cm. The side surfaces are arranged parallel to each other, and the driving element is arranged perpendicular to them, thus realizing the U-shape of the magnetic circuit. In particular, the two side surfaces are made of a ferromagnetic material, for example, iron. Preferably, an iron sheet is used as the material for the two side surfaces. The quenching chamber is positioned between the two side surfaces. Due to this configuration of the magnetic circuit, the quenching chamber is thus essentially permeated by a constant magnetic field that extends between the two side surfaces and is perpendicular to them.

Due to the arrangement of the driving element between the two limbs, a comparatively stable position can be achieved on the one hand, so that robustness is increased. In addition, an otherwise unused space is utilized in this way, providing a comparatively compact switching unit. If an alternating current is conducted via the switching unit, i.e., if an alternating voltage is applied between the fixed contact and the moving contact, in particular, a magnetic field is induced relatively effectively in the driving element due to the position between the two limbs of the busbar. This magnetic field is then shaped appropriately by the two side surfaces so that the (magnetic) short circuit is carried out through the quenching chamber. As a result, no additional component is required, which reduces manufacturing costs. In summary, the design of the magnetic circuit and the quenching chamber ensures that the arc remains in the quenching chamber once it has formed, wherein the quenching chamber is permeated by an essentially constant magnetic field, so that the arc is safely driven into the quenching element. This increases safety. It is also possible to stabilize the individual components in relation to each other, which makes production easier. Further, only relatively few components are required, and comparatively large manufacturing tolerances can be chosen for their positioning them relative to each other, thus simplifying production.

In its intended use, the switching unit can be used, for example, to conduct an alternating current, but preferably a direct current. In other words, when the electric current is conducted, it flows only in a single direction and/or a DC voltage is provided in particular by a possible voltage source. The electrical voltage is, for example, greater than 30 V and is in particular 48 V. Appropriately, the electrical voltage is less than 1500 V or less than 800 V. Preferably, the electrical voltage is equal to 830 V or 650 V, 380 V, 96 V or 48 V. The switching unit is used, for example, in an on-board electrical system of a motor vehicle, such as a passenger car or commercial vehicle, such as a truck or bus. Alternatively, the motor vehicle is, for example, a construction machine or agricultural machine. In a further development, the motor vehicle is a ship, boat or aircraft, such as an airplane. Alternatively, in its intended use, the switching unit is a component of a system such as a communication system, a data center or an industrial plant, in particular if the applied electrical voltage is greater than 100 V. In another alternative, the system is a component of a DC house installation or a DC-powered lighting system. For example, the switching unit is a component of an automatic circuit breaker or its miniature circuit breaker. The switching unit is suitable, in particular provided and configured for this purpose. For example, the switching unit is designed as a switch, via which an operation, i.e., a switching on/off, of an electrical circuit takes place.

For example, the two side surfaces can be shaped differently relative to each other. Thus, it is particularly possible to achieve a certain concentration of magnetic field lines. Particularly preferred, however, the two side surfaces are congruent with each other. In other words, in a projection, the two side surfaces are mapped perpendicular to their extension. This provides a comparatively homogeneous magnetic field. It is also possible to use identical parts.

For example, the driving element can be positioned outside the quenching chamber. Most preferably, the quenching chamber has a compartment in which the driving element is arranged. Thus, the driving element is stabilized by the quenching chamber, which further increases robustness. In addition, it is possible to manufacture the quenching chamber separately from the driving element and this is mounted by inserting it into the compartment. This makes it possible to select different driving elements for different applications, for example for use with an AC or DC voltage, while the other components are left the same, simplifying production. In other words, by selecting a suitable driving element, the switching unit is adapted to the respective area of application. Alternatively, for example, the driving element is overmolded with a material from which the quenching chamber is made, especially in plastic. This achieves a captive connection of the driving element, which increases robustness.

For example, the quenching chamber can be single-piece or comprises several components. Most preferably, however, the quenching chamber has two shells joined together, which are designed, for example, in the style of housing shells. It is possible to manufacture the two shells separately, and during assembly, for example, the quenching element, the fixed contact and the moving contact are arranged in one of the shells and the remaining shell is then joined to it. This simplifies production, while still achieving a relatively high level of robustness.

In particular, each of the shells can be made of plastic, preferably in an injection molding process. For example, the quenching chamber has other components, but the quenching chamber is particularly preferably formed via only the two shells. The shells, especially the separation plane of the shells, are preferably arranged parallel to the side surfaces, which simplifies production. For example, the two shells, in particular with the exception of any fastening elements, are mirror images of each other.

For example, the side surfaces can be spaced apart from the quenching chamber. However, it is particularly preferable to have one of the side surfaces lying against each of the shells, and each shell has a receptacle for the respective side surface. Conveniently, a clearance fit is formed between each mount and the assigned side surface, which makes assembly easier.

To join the shells, for example, they are either bonded together using a material bonded connection or, more appropriately, their contours interlock. In other words, the two shells are inserted into one another so that the quenching chamber is created. For example, joining is done using an additional fastening element, such as a screw, adhesive or welding. Particularly preferably, the two shells are joined together via the driving element, at least during assembly. Here, the driving element acts in particular on the two side surfaces, so that they attract each other magnetically. As a result, the two shells are also pressed together so that they are stabilized relative to each other. This simplifies production. For example, there is no additional fastening available. Preferably, the shells are also attached to each other, increasing robustness. In summary, the quenching chamber is therefore preferably made of a plastic, against which the two side surfaces, which are appropriately made of a metal, rest on the outside.

For example, the busbar may only be partially inserted into the quenching chamber or only protrudes into the quenching chamber at the end. Alternatively, the quenching chamber, for example, is limited on one side by the busbar. Preferably, the busbar is attached to the quenching chamber. In particular, the second limb is attached to the quenching chamber, and the first limb is located within the quenching chamber. Preferably, a module is provided that comprises the quenching chamber, the busbar with the fixed contact connected to it and the quenching element. In particular, these are stabilized in relation to each other, and in order to provide the switching unit, it is only necessary to arrange the moving contact, which is done in particular via the possible mechanics. In particular, the quenching chamber has a corresponding opening into which the moving contact is inserted. In this case, the opening is appropriately designed in such a way that an undisturbed movement of the moving contact with regard to the fixed contact is possible. For example, the mechanism is attached to the outside of the quenching chamber so that the switching unit is created. This simplifies production. It is also possible, for example, to use different mechanics, wherein the module is essentially always the same. Conveniently, the module also comprises the driving element and/or the quenching chamber includes the compartment for the driving element.

In its intended state, the module can be a component of a switching unit and is suitable, in particular provided and set up, for this purpose. The switching unit comprises a fixed contact and a movable moving contact that is mounted so as to be movable relative to the fixed contact as well as a quenching element, which are arranged in a quenching chamber. The fixed contact is connected to a first limb of a busbar that is U-shaped at least in sections and therefore has a second limb. Furthermore, the switching unit has a U-shaped magnetic circuit for driving an arc formed between the fixed contact and the moving contact into the quenching element, wherein the magnetic circuit has a driving element arranged between the first limb and the second limb, which is perpendicular to two parallel side surfaces of the magnetic circuit, the quenching chamber being arranged between the two side surfaces. The module has the quenching chamber and the busbar attached thereto, wherein the fixed contact is connected to the busbar. The quenching element is arranged in the quenching chamber, and in particular fixed there. Furthermore, the module also includes the driving element, which is located, for example, in a compartment of the quenching chamber. Appropriately, the module also has the other components of the U-shaped magnetic circuit, in particular the two side surfaces, which are conveniently attached to the outside of the quenching chamber. In addition, the quenching chamber has an opening for inserting the moving contact. This makes it possible to arrange the moving contact in the quenching chamber at a later date, and the module can be used essentially unchanged for the production of the switching unit.

The circuit breaker can be used in particular for safety, i.e., protection, of an electrical cable and/or a component, such as a device. In other words, the circuit breaker is therefore a line protection switch or a device protection switch. The circuit breaker has a switching unit. The switching unit comprises a fixed contact and a movable moving contact that is mounted so as to be movable relative to the fixed contact, as well as a quenching element, which are arranged in a quenching chamber. The fixed contact is connected to a first limb of a busbar that is U-shaped at least in sections and therefore has a second limb. Furthermore, the switching unit has a U-shaped magnetic circuit for driving an arc formed between the fixed contact and the moving contact into the quenching element, wherein the magnetic circuit has a driving element arranged between the first limb and the second limb, which is perpendicular to two parallel side surfaces of the magnetic circuit, the quenching chamber being arranged between the two side surfaces.

The circuit breaker can also include a switch lock, via which in particular the possible mechanics are provided. The moving contact is a component of the switch lock. Conveniently, the switch lock includes an interlocking mechanism via which the moving contact is held in a certain position. In particular the moving contact is in contact with the fixed contact. Appropriately, the switch lock includes another interlocking mechanism via which the moving contact is held in place if the moving contact is distanced from the fixed contact. This avoids an unintentional approach of the moving contact to the fixed contact, which leads to a new current being conducted via the circuit breaker. This increases safety. In particular, the switch lock comprises an element for exerting force on the moving contact, wherein the force is directed away from the fixed contact. Due to the interlocking mechanism, as long as it is engaged, the direct mechanical connection of the moving contact to the fixed contact is ensured.

In addition, the circuit breaker can include a trip mechanism that is electrically connected in series with the moving contact. Thus, if the moving contact is in contact with the fixed contact, the electric current is also conducted via the trip mechanism. In particular, the trip mechanism is used to monitor an electrical current carried through the circuit breaker. If the electric current meets a certain condition, the trip mechanism is tripped in particular, and the switch lock is then conveniently operated. This interrupts a current flow through the circuit breaker.

In particular, the circuit breaker can have a control input which is connected to the trip mechanism and/or other components of the circuit breaker in such a way that when a specific electrical signal is applied to it, the switch lock and/or the trip mechanism can be reset and/or operated. This enables remote commissioning and decommissioning, which increases convenience.

In particular, the circuit breaker can include a hand lever, such as a toggle lever, via which it is possible to operate the switch lock and/or the trip mechanism. The hand lever, for example, is used to operate the switching unit so that it is set to either the electrically conductive state or the electrically non-conductive state. For example, the trip mechanism and/or any interlocking mechanism is actuated by the hand lever so that the moving contact is spaced from the fixed contact.

For example, the circuit breaker can have a single-pole design. Alternatively, the circuit breaker has a multi-pole design, especially two-pole. Thus, the circuit breaker comprises two switching units, preferably with an assigned trip mechanism and/or switch lock. When one of the trip mechanisms or at least one of the switching units is actuated, the other is also actuated. This enables comparatively safe separation via the circuit breaker.

For example, the trip mechanism can be a bimetallic snap disc. However, the trip mechanism is particularly preferred to be designed as a hydraulic-magnetic mechanism. Thus, a magnetic field is created via the trip mechanism when an electric current is passed through it. Only when the created magnetic field exceeds a certain threshold is the possible interlocking mechanism released, so that the moving contact is spaced from the fixed contact.

In this case, a hydraulic system can be surrounded by the electrical coil, which, for example, creates damping, thus delaying the tripping process, in particular. At a minimum, however, the trip mechanism is designed as a hydraulic-magnetic mechanism. Consequently, a delay of the trip mechanisms can be adjusted by the hydraulic system. Alternatively, the trip mechanism, for example, is designed to be thermally magnetic. A bimetal element and an electric coil are present. The bimetal element is tripped in the event of an overload, so that the switching unit is actuated. The electric coil, on the other hand, releases the switch lock when a short-circuit current is present, resulting in a comparatively fast separation.

For example, the circuit breaker can be essentially formed via the switching unit, the switch lock and the trip mechanism, which are arranged within a corresponding circuit breaker housing, for example. Alternatively, the circuit breaker includes other components, such as a fuse in particular. This is conveniently connected electrically in series with the moving contact. The fuse is, for example, a wire fuse. In particular, a characteristic curve of the fuse is designed in such a way that it is tripped in the event of overcurrents, thus interrupting the flow of electric current. The switching unit, on the other hand, is used in particular for the deliberate switching of an electrical current, i.e., at a rated current, and/or in the event of an overload.

Appropriately, the circuit breaker can include an electrical circuit via which the state of the fuse is monitored. In particular, the wiring is such that signaling takes place if the fuse is not electrically conductive. For example, a corresponding level (in particular an electrical voltage) is applied to a corresponding terminal of the circuit breaker, to which, for example, a corresponding signal line is connected in the assembly state. Alternatively or in combination thereto, the circuit breaker has, for example, a signaling device, such as a light source, in particular an LED, which is installed in the possible circuit breaker housing, for example. In particular, the signaling device is operated when the fuse is not electrically conductive. This means that it can be seen from outside the circuit breaker whether the fuse has tripped, so that the fuse must be replaced in order to restart the circuit breaker. It is not necessary to open the circuit breaker housing for this. This simplifies maintenance.

For example, the fuse and the switching unit can be arranged in two separate circuit breaker housings. However, it is particularly preferred for the fuse and the switching unit to be arranged in a common switch housing, which simplifies installation.

In particular, the circuit breaker housing can have a fuse compartment in which the fuse is located. The fuse compartment is accessible from outside the circuit breaker housing. This makes it possible to replace the fuse from outside without opening the circuit breaker housing. As a result, maintenance is simplified. Conveniently, the fuse compartment is covered by a lid to prevent the ingress of foreign particles. This also provides protection against contact. In particular, the lid on the circuit breaker housing is hinged in a swivel position.

Appropriately, the circuit breaker can include an auxiliary mechanism that is assigned to the fuse. For example, the fuse is installed in the auxiliary mechanism and/or the auxiliary mechanism is arranged within the fuse compartment. For example, to insert the fuse, the auxiliary mechanism is at least partially inserted into the fuse compartment.

The auxiliary mechanism, for example, can be designed in such a way that the switch lock is actuated when force is applied to the fuse. If a person pulls on the fuse because it is to be removed from the fuse compartment, the switch lock is first actuated so that an electric current is carried through the fuse. This increases safety. Alternatively or in combination hereto, the switch lock is actuated when the force is applied in the direction of the fuse compartment, i.e., when the fuse is to be installed in the fuse compartment. This also ensures that after the fuse has been installed, no immediate current is carried through the circuit breaker, which also increases safety. For example, the auxiliary mechanism has a bolt that acts on the switch lock when the force is applied to the fuse. If the switch lock was already actuated, i.e., in particular is in the electrically non-conductive state and thus the moving contact is distanced from the fixed contact, no activity is carried out via the auxiliary mechanism, so that undisturbed movement of the fuse is possible. Alternatively or in combination thereto, the auxiliary mechanism prevents movement of the fuse if the moving contact is in contact with the fixed contact. In summary, the auxiliary mechanism thus ensures that the fuse can only be replaced without potential, which increases safety.

The invention also relates to a motor vehicle. The motor vehicle is, for example, land-based and, for example, a passenger car. However, the motor vehicle is particularly preferred to be a commercial vehicle, such as a bus or, most preferably, a truck. The motor vehicle has a high-voltage on-board electrical system, through which a direct voltage between 400 V and 800 V is carried in particular. Furthermore, the motor vehicle includes a low-voltage on-board electrical system, via which a direct voltage of 12 V, 24 V or 48 V is conveniently supplied. In this context, the low-voltage on-board electrical system is used in particular to supply power to auxiliary units of the motor vehicle, via which, for example, comfort functions or the like are provided. The high-voltage on-board electrical system is used in particular to power a main drive, which is conveniently equipped with an electric motor. Here, the main drive system is preferably electrically connected to a high-voltage battery via the high-voltage on-board electrical system, which is used to supply the high-voltage on-board electrical system. The low-voltage on-board electrical system is powered, for example, via a transformer through the high-voltage on-board electrical system or via a separate battery. The motor vehicle includes a circuit breaker. The circuit breaker is conveniently located electrically between the high-voltage battery and the main drive.

Furthermore, the invention also relates to the use of such a circuit breaker to protect a high-voltage on-board electrical system of a motor vehicle.

The further developments and advantages explained in connection with the switching unit are also to be transferred mutatis mutandis to the module/the circuit breaker/the motor vehicle/the use as well as to each other, and vice versa.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 schematically shows, a circuit with a circuit breaker,

FIG. 2 shows the circuit breaker in perspective,

FIGS. 3, 4 shows in perspective or in a plan view, the circuit breaker containing a module, wherein part of the circuit breaker housing is omitted,

FIG. 5 shows in a sectional view, the circuit breaker,

FIG. 6 shows in perspective, the module comprising a quenching chamber,

FIG. 7 shows in perspective, the module, wherein the quenching chamber is omitted,

FIG. 8 shows in perspective, a quenching element of the quenching chamber,

FIGS. 9-11 show in perspective, examples of the quenching element, and

FIGS. 12,13 show in accordance with FIG. 4 and FIG. 5 respectively, a further development of the circuit breaker.

### DETAILED DESCRIPTION

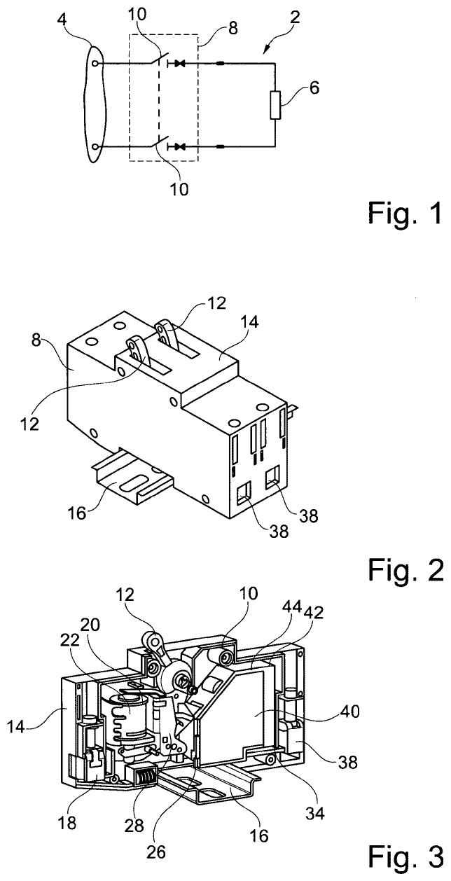

FIG. 1 shows a circuit 2 that has a DC voltage source 4. The DC voltage source 4 is electrically connected to a load 6, so that the load 6 is energized by the DC voltage source 4. A circuit breaker 8 is electrically inserted between the DC voltage source 4 and the load 6, so that the electric current between the DC voltage source 4 and the load 6 is conducted via the circuit breaker 8.

The circuit breaker 8, which is shown in perspective in FIG. 2, has a two-pole design. In other words, it is possible to electrically isolate the two electrical potentials of the DC source 4 from the load 6 via the circuit breaker 8. For this purpose, the circuit breaker 8 has two switching units 10, wherein one of the switching units 10 is assigned to each of the electrical potentials. The two switching units 10 are mechanically coupled with each other, so that when one of the two switching units 10 is actuated, the other switching unit 10 is also actuated. Each switching unit 10 is assigned a hand lever 12, which protrudes from a circuit breaker housing 14, so that the respective switching unit 10 can be manually operated from outside the circuit breaker housing 14. The circuit breaker housing 14, which is made of plastic, is designed for mounting on a DIN rail 16.

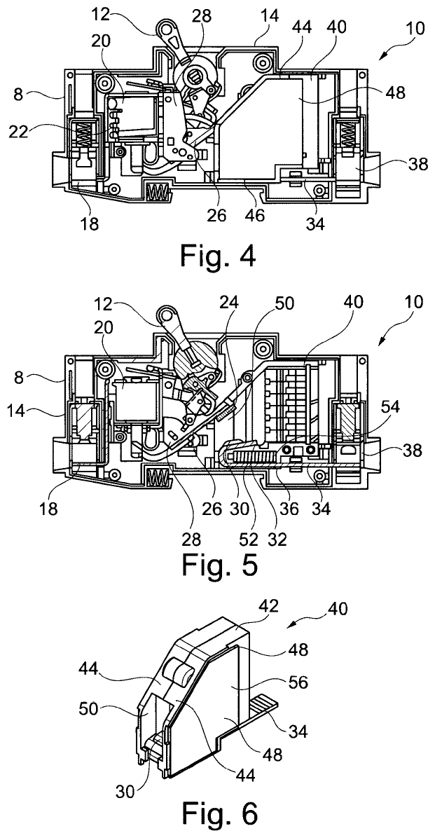

In FIG. 3 and in FIG. 4 in a plan view, one of the two switching units 10 arranged in the circuit breaker housing 14 is shown in perspective, wherein part of the circuit breaker housing 14 is omitted. FIG. 5 shows the corresponding switching unit 10 in a sectional view. The switching unit 10 has a first terminal 18, which is inserted in a corresponding opening of the circuit breaker housing 14. The first terminal 18 is used to accommodate and attach an unspecified cable of the circuit 2.

The first terminal 18 is electrically contacted with a trip mechanism 20 which has an electric coil 22 as well as an unspecified hydraulic reservoir. Thus, the trip mechanism 20 is designed to be hydraulic-magnetic. Via the trip mechanism 20, the first terminal 18 is electrically contacted with a moving contact 24. Thus, the trip mechanism 20 is electrically connected in series to the moving contact 24, which is arranged on the end side of a swiveling contact bridge 26. The moving contact 24 and the contact bridge 26 are components of a switch lock 28, which has an unspecified latch and a mechanical spring via which the contact bridge 26 is pressurized. Via the latching, it is possible to hold the contact bridge 26 in a certain position, although the spring force acts on the contact bridge 26. The latch can be released via the trip mechanism 20, so that the contact bridge 26 is moved due to the spring force applied. It is also possible to release the latch via the hand lever 12, so that the contact bridge 26 is subsequently also swiveled. It is also possible to use the hand lever 12 to move the contact bridge 26 back to the original position and to activate the latch so that the contact bridge 26 is again in the specified position until the latch is released.

Via the contact bridge 26 and the other components of the switch lock 28, the moving contact 24 is movably supported with respect to the circuit breaker housing 14 and also with regard to a fixed contact 30. The switch lock 28 and thus the switching unit 10 is designed in such a way that the moving contact 24 can be moved such that it mechanically lies directly against the fixed contact 30. If this is the case, the latch in particular engages, so that until the latch is released, the moving contact 24 mechanically rests against the fixed contact 30. As soon as the latch is released, the moving contact 24 is spaced apart from the fixed contact 30 due to the acting spring force.

The fixed contact 30 is connected to a first limb 32 of a U-shaped busbar 34, which is made of copper. Thus, the busbar is bent on itself, which is why a second limb 36 is formed. The fixed contact is on the side of the first limb 32 that is opposite the second limb 36. The second limb 36 is elongated as compared to the first limb 32 and extends to a second terminal 38, which is located in a correspondingly different opening of the circuit breaker housing 14. In the assembly state, another cable of the circuit 2 is attached to the second terminal 38 and electrically contacted with it. Thus, if the switching unit 10 is appropriately adjusted, i.e., if the moving contact 24 is mechanically directly in contact with the fixed contact 30, the two terminals 18, 38 are connected to each other in a low-impedance manner, so that an electrical current flow can take place between them. If, on the other hand, the switching unit 10 is actuated, i.e., open, and thus the moving contact 24 is distanced from the fixed contact 30, the two terminals 18, 38 are galvanically isolated from each other. In summary, the circuit breaker 8 comprises the switching unit 10, wherein the moving contact 24 is a component of the switch lock 28 and electrically connected in series with a trip mechanism 20. In particular, the other components of the switch lock 28 and trip mechanism 20 are not components of the switching unit 10.

The busbar 34 is a component of a module 40, which is shown in perspective in FIG. 6. Module 40 has a quenching chamber 42, which has two shells 44 joined together. The shells 44 are mirror images of each other and are made of a plastic, namely PBT. The separation plane of the two shells 44, i.e., the plane along which they are joined together, is perpendicular to the swivel axis of the contact bridge 26. Each of the shells 44 has an external receptacle 46, in which a side surface 48 is inserted. The side surfaces 48 are arranged parallel to the separation plane and are mirror images of it, and therefore congruent with each other. The side surfaces 48 are identical to each other and are made of a ferromagnetic material, namely a sheet of iron.

The busbar 34 extends into the quenching chamber 42 and is attached to it. For this purpose, the busbar 34 is held in corresponding, unspecified receptacles or guides of the two shells 44. When the two shells 44 are joined together, the busbar 34 is attached to the quenching chamber 42. In a further development, for example, an adhesive is also used to attach the busbar 34 in the two shells 44. In another alternative, the adhesive that attaches the busbars 34 to the two shells 44 is used to join the two shells 44 together. In summary, the busbar 34 is attached to the quenching chamber 42.

The fixed contact 30 is located inside the quenching chamber 42. The quenching chamber 42 has an opening 50 through which the moving contact 24 can be inserted into the quenching chamber 42 during installation, so that it is also inside the quenching chamber 42 when it is assembled. The opening 50 is designed in such a way that undisturbed movement of the contact bridge 26 is possible. However, the opening 50 is not designed to be larger than necessary, so that the quenching chamber 42 is otherwise closed.

The quenching chamber 42 has a compartment 52 covered by the side surfaces 48, within which a driving element 54 is arranged. The driving element 54 is a permanent magnet if the circuit 2 carries a direct voltage. If an alternating voltage is conducted via the circuit 2, the driving element 54 is made of a steel. The compartment 52 is present in the plastic of the two shells 44, and between the driving element 54 and the shells 44 there is, for example, a press fit or a clearance fit. For example, the driving element 54 is mounted in the compartment 52 if the two shells 44 are joined together, or alternatively for production, for example, the driving element 54 is already inserted into the part of the compartment 52 which one of the two shells 44 has, and then the other shells 44 are joined to it, wherein the driving element 54 is inserted into the other part of the compartment 52.

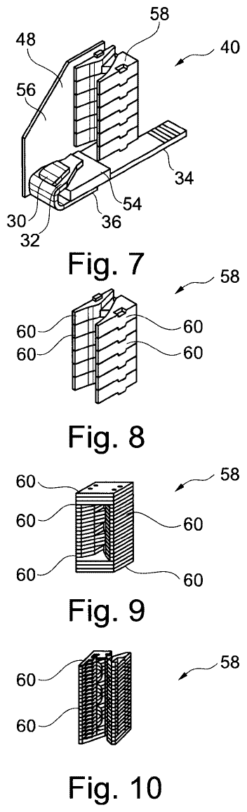

FIG. 7 also shows the module 40 in perspective, wherein the quenching chamber 42 is not shown. Also, one of the two side surfaces 48 is not shown. The driving element 54 rests at the end of the opposite side surfaces 48, so that a U-shaped magnetic circle 56 is formed. In other words, the magnetic circuit 56 has the driving element 54 and the two side surfaces 48. The driving element 54 and thus also the compartment 52 are arranged between the two limbs 32, 36 of the busbar 36. If the circuit 2 carries an alternating voltage, an induction of a magnetic field into the driving element 54 is improved there.

The magnetic field provided by the driving element 54 is thus deflected via the two side surfaces 48 and emerges vertically from them, so that a magnetic field directed parallel to the driving element 54 is provided, via which the quenching chamber 42 is penetrated. If the driving element 54 is designed as a permanent magnet, the two side surfaces 48 are drawn to the driving element 54 due to the acting magnetic forces, so that the shells 44 arranged between them are pressed together, which increases the stability of the module 40. In summary, the magnetic circuit 56 thus has the driving element 54 arranged between the first limb 32 and the second limb 36, which is perpendicular to the two parallel side surfaces 48 of the U-shaped magnetic circuit 56. The quenching chamber 42 is arranged between the two side surfaces 48. The module 40 also includes a quenching element 58, which is arranged within the quenching chamber 42. In this case, the quenching element 58 is in the corresponding internal receptacles of the two shells 44 and is stabilized there.

The quenching element 58 is shown in perspective in FIG. 8 and has several wedge-shaped stacked quenching strips 60, between which an unspecified meandering gap is formed. The quenching strips 60 are made of a ceramic that is electrically non-conductive. Also, the quenching strips 60, i.e., the wedges, are identical parts that are arranged in different orientations, so that an essentially V-shaped notch is formed, which points in the direction of the fixed contact 30 and the moving contact 24. Also, the quenching strips 60 have interlocking structures, via which an intrinsic stability of the quenching element 58 is provided.

FIG. 9 shows an example of the quenching element 58. In this example, the thickness of the quenching strips 60 is reduced, and some of them have different shapes. The quenching strips 60 are also made of a ceramic, and between them the V-shaped notch is also formed in sections, which is directed in the direction of the two contacts 24, 30. The meandering, unspecified gap is also present.

FIG. 10 shows an example of the quenching element 58, which has the quenching strips 60 stacked on top of each other. However, these are made of a metal and spaced by unspecified spacers.

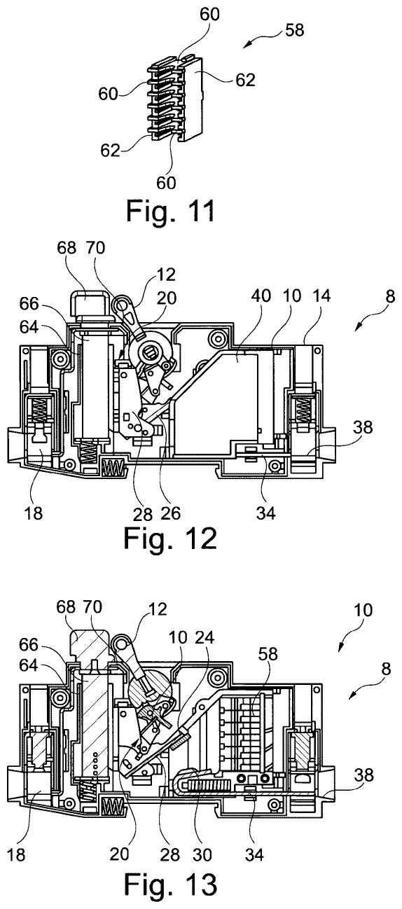

FIG. 11 shows an example of the quenching element 58. This has two opposing holders 62 made of a ceramic or a plastic, into which the quenching strips 60 are inserted and via which they are held. The quenching strips 60 are made of a metal and spaced from each other via the two holders 62.

When the circuit breaker 8 is operated as intended, an electric current is conducted between the two terminals 18, 38. If the hand lever 12 is actuated or the trip mechanism 20 is tripped, the switching unit 10 is activated and thus opened. Thus, the moving contact 24 that had previously been adjacent to the fixed contact 30 is distanced from it. If the electrical voltage provided by the circuit 2 is sufficiently high, it is possible that the air present between the contacts 24, 30 is ionized, so that an arc is formed, and therefore an electric current flow between the two terminals 18, 28 continues. Here, the arc acts as an electrical conductor. Since the magnetic field of the magnetic circuit 56 permeates the quenching chamber 42, the Lorentz force acts on the arc, due to which the arc moves in the direction of the quenching element 58 and is partially bulged. In this process, part of the arc is partially moved into the quenching element 58. The length of the arc is already increased due to the bulge, which is why the electrical voltage required to maintain it increases. As soon as the arc enters the quenching element 58, further deformation occurs, and depending on the quenching element 58 used, it is possible for the arc to split into several individual (partial) arcs. The arc is also cooled via the quenching element 58. All of this causes the electrical voltage required to maintain the arc to continue to rise. If this is greater than the electrical voltage between the two terminals 18.28, the arc breaks down and the electrical current flow between the two terminals 18, 28 is safely interrupted, with galvanic isolation due to the moving contact 24 separated from the fixed contact 30.

Thus, the magnetic circuit 56 serves to drive the arc formed between the fixed contact 30 and the moving contact 24 into the quenching element 58 if the arc is present. As long as the arc is present, it is surrounded by the quenching chamber 42, so that, on the one hand, electrical contact of other components of the circuit breaker 8 with the arc is avoided. Thermal insulation is also provided via the quenching chamber 42, so that a load on the other components of the circuit breaker 8 is reduced.

FIGS. 12 and 13 show an example of the circuit breaker 8 in accordance with FIGS. 4 and 5, wherein the switching unit 10 is not changed. Also present are the circuit breaker housing 14 as well as the hand lever 12 and the two terminals 18, 38. The switch lock 28 is also available. The circuit breaker 8 has the trip mechanism 20, which, however, is only designed as a bimetallic snap disc, so that the circuit breaker 8 is a thermal circuit breaker. In an unspecified variant, the electric coil is still present, so that the trip mechanism 20 is designed to be thermally magnetic. In an unspecified variant, there is no trip mechanism and the circuit breaker 8 is operated by remote release or only via the hand lever 12.

The circuit breaker housing 14 has a fuse compartment 64 within which a fuse 66 in the form of a wire fuse is arranged. Electrically, the fuse 66 is arranged between the moving contact 24 and the first terminal 18. In other words, the fuse 66 is electrically connected in series with the moving contact 34, so that the electric current conducted between the two terminals 18, 38 is also conducted via the fuse 66.

The fuse compartment 64 ends at the outside of the circuit breaker housing 14 and is closed on the outside via a lid 68 which can be swiveled to the circuit breaker housing 14. This means that the fuse compartment 64 can be accessed from outside the circuit breaker housing 14, namely by swiveling the lid. Here, the lid 68 is a component of an auxiliary mechanism 70, which is actuated via the hand lever 12. In this case, at a certain position of the hand lever 12, the auxiliary mechanism 70 prevents the lid 68 from swiveling in such a way that the fuse compartment 64 is released. This occurs when the position of the hand lever 12 corresponds to the open switching unit 10, i.e., when the moving contact 24 is in contact with the fixed contact 30. Since the safety compartment 64 is closed via the lid 68, there is no room for movement for the fuse 66. Thus, the auxiliary mechanism 70 is designed in such a way that if the moving contact 24 is in contact with the fixed contact 30, movement of the fuse 66 is prevented.

If there is a malfunction or if the hand lever 12 is moved with the lid 68 open in such a way that the moving contact 24 is in contact with the fixed contact 30, the auxiliary mechanism 70 is used to flip the hand lever 12 in the event of a force being applied to the fuse 66, for example when attempting to remove it from the fuse compartment 64 or when attempting to insert it into the fuse compartment 64, so that the switch lock 28 is actuated and thus the moving contact 24 is spaced apart from the fixed contact 30. In other words, the switching unit 10 is actuated. Thus, only a potential-free removal or insertion of the fuse 66 is possible.

There is also an unspecified circuit via which the state of the fuse 66 is monitored. If this is electrically non-conductive, in particular because it is damaged or tripped, a signaling device located on the outside of the circuit breaker housing 14, namely an unspecified LED, is activated, so that it can be seen from outside the circuit breaker housing 14 that the fuse 66 is no longer suitable for carrying the electrical current.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A switching unit comprising:
a fixed contact connected to a first limb of a busbar that is U-shaped at least in sections, the busbar also having a second limb;
a moving contact that is mounted so as to be movable relative to the fixed contact;
a quenching element;
a quenching element, the fixed contact, the moving contact, and the quenching element being arranged in the quenching chamber; and
a U-shaped magnetic circuit to drive an arc formed between the fixed contact and the moving contact into the quenching element,
wherein the magnetic circuit comprises a driving element that is arranged between the first limb and the second limb, which is substantially perpendicular to two parallel side surfaces of the magnetic circuit, and
wherein the quenching chamber is positioned between the two side surfaces.

2. The switching unit according to claim 1, wherein the two side surfaces are congruent with each other.

3. The switching unit according to claim 1, wherein the quenching chamber comprises a compartment, in which the driving element is arranged.

4. The switching unit according to claim 1, wherein the quenching chamber has two shells joined together, against which one of the side surfaces rests on an outside.

5. The switching unit according to claim 1, wherein the busbar is attached to the quenching chamber.

6. A module for the switching unit according to claim 5, the module comprising:
a quenching chamber with the busbar attached to it, to which the fixed contact is connected; and
the driving element,
wherein the quenching element is arranged in the quenching chamber, and
wherein the quenching chamber has an opening for inserting a moving contact.

7. A circuit breaker comprising:
the switching unit according to claim 1,
wherein the moving contact is a component of a switch lock and electrically connected in series with a trip mechanism.

8. The circuit breaker according to claim 7, wherein the trip mechanism is designed to be hydraulic-magnetic or thermal-magnetic.

9. The circuit breaker according to claim 7, wherein a fuse is electrically connected in series with the moving contact.

10. The circuit breaker according to claim 8, wherein the fuse is arranged in a fuse compartment of a circuit breaker housing, and wherein the fuse compartment is accessible from outside the circuit breaker housing.

11. The circuit breaker according to claim 10, wherein an auxiliary mechanism is assigned to the fuse, which is designed such that the switch lock is actuated if a force is applied to the fuse and/or movement of the fuse is prevented if the moving contact is in contact with the fixed contact.
